(19) United States
(12) Patent Application Publication
(10) Pub. No.: US 2011/0008608 A1
(43) Pub. Date: Jan. 13, 2011

(54) COMPOSITE MOLDING IN PARTICULAR FOR FURNITURE CONSTRUCTION

(75) Inventors: Ingo Bellin, Mannheim (DE); Carsten Schips, Speyer (DE); Klaus Hahn, Kirchheim (DE); Stephan Weinkötz, Neustadt (DE); Jochen Gassan, Landau (DE); Jens Assmann, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Carl-Bosch-Strasse; Ludwigshafen (DE)

(21) Appl. No.: 12/921,449

(22) PCT Filed: Mar. 2, 2009
(86) PCT No.: PCT/EP09/52466

§ 371 Date: Sep. 8, 2010

(30) Foreign Application Priority Data
Mar. 10, 2008 (EP) 08152528.9

(51) Int. Cl. B32B 5/18; B29B 9/16

(52) U.S. Cl. 428/305.5; 264/7

(57) ABSTRACT

A composite molding, in particular for furniture construction, comprises a core layer and one or more further layers, where the core layer takes the form of a molded-foam molding, obtainable via fusion of prefoamed foam beads composed of expandable, thermoplastic polymer pellets comprising
from 5 to 100% by weight of an AMSAN component (A) comprising
a1) from 5 to 100% by weight (based on A) of a styrene-acrylonitrile copolymer
a2) from 0 to 95% by weight (based on A) of an α-methylstyrene-acrylonitrile copolymer and/or α-methylstyrene-styrene-acrylonitrile terpolymer;
from 0 to 95% by weight of polystyrene (B), and
from 0 to 95% by weight of a thermoplastic polymer (C) different from (A) and (B).

The invention relates to a composite molding, in particular for furniture construction, comprising a core layer composed of a fused molded foam, and comprising at least one further layer, to a process for its production, and also to the use of the composite molding in furniture construction.

Composite moldings for use in the furniture industry have been known for a long time. They have further layers alongside a core layer, examples being outer sublayers, foils, or veneers, and also, if appropriate, have a stabilizing frame structure. If these composite moldings are intended for use as lightweight components, a core layer with minimum density is desirable, but this cannot be permitted to have any great adverse effect on the other performance characteristics.

German utility model DE 296 09 442 U1 describes a molding, in particular for furniture or furniture parts, which comprises a core layer composed of a paper honeycomb material, outer layers composed of, for example, particle board or MDF (medium-density fiberboard) as outer sublayers, and a frame structure. A disadvantage here is that the frame structure is essential for reasons of stability, and that it is difficult to attach accessories, since the core layer is not solid.

LU-A 80594 describes a sandwich element with a honeycomb sheet composed of aluminum. There are economic disadvantages due to the use of aluminum, which is expensive, and here again it is difficult to attach accessories.

German utility model DE 202005012486 U1 describes door preforms composed of a lightweight board with polyurethane (PU) core. A disadvantage here is not only the high price of polyurethane but also the difficulty in recycling this material.

Lightweight board with a core composed of expanded polystyrene (EPS) are marketed by SWL-Tischlerplatten-Betriebs-GmbH (Langenberg, Westfalen, Germany). These sheets, too, require a frame structure.

Although, therefore, the known lightweight board for furniture construction already achieve good results, much scope remains for improvements, in particular concerning a combination of low density with good processability and with advantageous performance characteristics.

It was therefore an object to provide a composite molding which is intended for furniture construction and which, with minimum density, requires no frame structure, and which can easily be coated using conventional technologies.

It has been found that composite moldings with particularly advantageous properties are obtained if the core layer takes the form of a molded-foam molding and the underlying expandable, thermoplastic polymer pellets comprise a styrene-acrylonitrile copolymer (SAN).

The invention therefore provides a composite molding, in particular for furniture construction, comprising a core layer and one or more further layers, where the core layer takes the form of a molded-foam molding, obtainable via fusion of prefoamed foam beads composed of expandable, thermoplastic polymer pellets comprising
from 5 to 100% by weight of an SAN component (A) comprising
   a1) from 5 to 100% by weight (based on A) of a styrene-acrylonitrile copolymer and
   a2) from 0 to 95% by weight (based on A) of an α-methylstyrene-acrylonitrile copolymer and/or α-methylstyrene-styrene-acrylonitrile terpolymer;
from 0 to 95% by weight of polystyrene (B), and
from 0 to 95% by weight of a thermoplastic polymer (C) different from (A) and (B).

The composite moldings of the invention require no frame structure, with densities from 50 to 100 g/l, and they have high pressure resistance and are easier to process than materials such as EPS, because they have good heat resistance. The molded foam used according to the invention can be fused to give any desired shapes, and sheets of any desired density are therefore easy to produce, as also are relatively complex three-dimensional shapes. In particular, composite moldings with content of α-methylstyrene-acrylonitrile (AMSAN) co- or terpolymers exhibit high heat resistance.

The invention also provides the use of a composite molding according to the invention in furniture construction.

The invention also provides a process for the production of a composite molding according to the invention, comprising the steps of
a) polymerization of styrene monomers, if appropriate, α-methylstyrene or acrylonitrile or styrene, to give styrene copolymers (A) or polystyrene (B),
b) devolatilization of the resultant polymer melt,
c) if appropriate, mixing of the other polymers of components (A), (B), and (C),
d) using a static or dynamic mixer at a temperature of at least 150° C., preferably from 180 to 260° C., for mixing to incorporate the blowing agent and, if appropriate, additives into the polymer melt,
e) cooling of the polymer melt comprising blowing agent to a temperature which is at least 120° C., preferably from 150 to 230° C.,
f) discharge through a die plate with holes whose diameter at the die exit is at most 1.5 mm,
g) pelletization of the melt comprising blowing agent,
h) foaming and fusion of the resultant pellets to give a molding, and
i) application of at least one further layer.

The density of the molded foams used according to the invention for the core layer is generally from 5 to 500 g/l, preferably from 10 to 250 g/l, particularly preferably from 15 to 150 g/l.

The resultant molded-foam moldings have a high closed-cell factor, and the proportion of closed cells in individual foam beads is generally more than 60%, preferably more than 70%, particularly preferably more than 80% of the cells.

The thermoplastic polymer pellets used particularly preferably comprise from 50 to 100% by weight of SAN component (A), and from 0 to 50% by weight of thermoplastic polymer (C).

A preferred SAN component (A) is provided by mixtures comprising from 10 to 100% by weight, preferably from 20 to 100% by weight, more preferably from 60 to 100% by weight, particularly preferably from 0 to 50% by weight (based in each case on (A)) of component (a1), and from 0 to 90% by weight, preferably from 0 to 80% by weight, particularly preferably from 0 to 50% by weight (based in each case on (A)), of component (a2).

In a preferred embodiment the SAN component (A) comprises 100% by weight of component (a1).

In another preferred embodiment SAN component (A) comprises 10 to 99, preferably 20 to 90, more preferably 40 to 80, particularly preferably 50 to 80% by weight (in each case based on (A)) of component (a1), and 1 to 90, preferably 10 to 80, more preferably 20 to 60, particularly preferably 20 to 50% by weight (in each case based on (A)) of component (a2).

A preferred styrene-acrylonitrile copolymer (SAN) (a1) is provided by SAN grades obtainable from
(a 11) from 7 to 45% by weight, preferably from 17 to 35% by weight, based on (a1), of acrylonitrile, and
(a 12) from 55 to 93% by weight, preferably from 65 to 83% by weight, based on (a1), of styrene.

A preferred component (a2) is provided by α-methylstyrene-acrylonitrile copolymers (AMSAN) (a21).

A preferred AMSAN is provided by copolymers (a21) obtainable from
(a211) from 10 to 50% by weight, preferably from 17 to 43% by weight, particularly from 27 to 33% by weight (based on (a21)), of acrylonitrile, and
(a212) from 50 to 90% by weight, preferably from 57 to 83% by weight, particularly preferably from 67 to 73% by weight (based on (a21)), of α-methylstyrene.

Preferred α-methylstyrene-styrene-acrylonitrile terpolymers (a22) are provided by polymers obtainable from
(a221) from 61 to 85% by weight (based on (a22)) of α-methylstyrene,
(a222) from 1 to 15% by weight (based on (a22)) of styrene, and
(a223) from 14 to 34% by weight (based on (a22)) of acrylonitrile.

By way of example, the polystyrene (B) used can comprise free-radical-polymerized glassclear polystyrene (GPPS), impact-modified polystyrene (HIPS), or anionically polymerized polystyrene (APS), or anionically polymerized impact-resistant polystyrene (AIPS).

In a preferred embodiment the polymer pellets according to the invention do not comprise polystyrene (B) (0% by weight).

In a further preferred embodiment the polymer pellets according to the invention comprise 1 to 95, preferably 10 to 80% by weight polystyrene (B), whereby the maximum upper limit for component (A) is reduced accordingly.

The thermoplastic polymer (C) used can by way of example comprise acrylonitrile-butadiene-styrene (ABS), acrylonitrile-styrene-acrylate (ASA), polyamide (PA), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfone (PES), polyether ketones (PEK), polyether sulfides (PES), or a mixture thereof. Polyamide (PA) is preferred.

In a preferred embodiment the polymer pellets according to the invention comprise 1 to 95, preferably 10 to 50% by weight of thermoplastic polymer component (C), whereby the maximum upper limit for component (A) is reduced accordingly. In this embodiment the thermoplastic polymer component (C) is preferably polyamide.

The constitution of the polymer pellets can be selected to be appropriate for the desired properties of the molded-foam molding. Heat resistance is improved with the polymer mixtures used according to the invention, in particular when AMSAN is used.

In order to obtain pellets of minimum size during the production of the polymer pellets used according to the invention, there should be minimum die swell after the die exit. It has been found that die swell can be influenced inter alia via the molecular-weight distribution of the SAN. The molecular-weight distribution of the expandable SAN should therefore preferably have a polydispersity M_{w}/Mₙ of at most 3.5, particularly preferably from 1.5 to 2.8, and very particularly preferably from 1.8 to 2.6.

Examples of suitable compatibilizers are maleic-anhydride-modified styrene copolymers, polymers comprising epoxy groups, or organosilanes.

The molded foams used according to the invention can be produced by conventional methods known to the person skilled in the art, e.g. suspension polymerization.

By way of example, the polymer composition is melted in an extruder, if appropriate mixed in the melt with additives, and then pelletized, and the pellets are post-impregnated with blowing agent, preferably in aqueous suspension.

Impregnation with the blowing agent here preferably takes place in a pressure-resistant stirred vessel. Operations preferably take place in aqueous suspension or else ethylene glycol, generally using from 90 to 350 parts, preferably from 100 to 300 parts, of water for every 100 parts of polymer.

In order to prevent caking of the polymer beads, it is advantageous to operate in the presence of known suspending agents, such as very fine-particle aluminum oxide, basic magnesium carbonate, basic zinc carbonate, calcium carbonate, calcium phosphate, kieselguhr. Conventional water-soluble polymers are also suitable as dispersing agents, and these markedly increase the viscosity of the aqueous phase, an example being a liquid phase (serum) in emulsion polymerization of styrene.

The amounts generally used of the dispersing agent are from 0.1 to 10 parts, preferably from 0.1 to 4.0 parts, for every 100 parts of water.

The dispersion is heated together with the blowing agent (such as pentane) to a temperature at which the polymer softens. This softening point is generally lower in the presence of the blowing agent, which generally diffuses to some extent into the polymer particles even before heating, or during the heating procedure, than the softening point of the straight polymer mixture. The ideal temperature can easily be determined by a preliminary experiment. It is from 100 to 250° C. The pressure during the impregnation process is in essence determined via the vapor pressure of the water and of the blowing agent and is generally from 8 to 60 bar.

Once the softening point has been reached, the dispersion is preferably kept for some further time at this temperature, an example being from 1 to 100 minutes. The material is then cooled, and the expandable polymer is isolated from the suspension, and, if appropriate, washed and dried.

Melt impregnation is preferred, however, this being treatment of the polymers with blowing agent in the melt stream as described by way of example in WO 03/106544.

The polymer melt can also receive admixtures of recycled polymers from the thermoplastic polymers mentioned, in particular styrene polymers and expandable styrene polymers (EPS), in amounts which do not substantially impair its properties, the amounts generally being at most 50% by weight, in particular from 1 to 20% by weight.

The polymer melt comprising blowing agent generally comprises one or more blowing agents homogeneously distributed in a total proportion of from 2 to 10% by weight, preferably from 3 to 7% by weight, based on the polymer melt comprising blowing agent. Suitable blowing agents are the physical blowing agents usually used in EPS, e.g. aliphatic hydrocarbons having from 2 to 8 carbon atoms, alcohols, ketones, ethers, esters, or halogenated hydrocarbons. Preference is given to use of isobutane, n-butane, isopentane, or n-pentane. Preferred co-blowing agents are ethanol, acetone, and methyl formate.

To improve foamability, finely dispersed internal water droplets can be introduced into the polymer matrix. This can be achieved by way of example via addition of water to the molten polymer matrix. The water may be added at a point prior to, together with, or after the feed of blowing agent. Homogeneous dispersion of the water can be achieved by means of dynamic or static mixers.

From 0 to 2% by weight, preferably from 0.05 to 1.5% by weight, of water, based on the entire polymer component, is generally sufficient.

When they are foamed, expandable polymer pellets with at least 90% of the internal water in the form of internal water droplets whose diameter is in the range from 0.5 to 15 μm form foams with adequate cell number and with homogeneous foam structure.

The amount of blowing agent and water added is selected in such a way that the expansion capability a of the expandable polymer pellets, defined as bulk density prior to foaming/bulk density after foaming, is at most 125, preferably from 25 to 100.

The bulk density of the expandable polymer pellets used according to the invention is generally at most 700 g/l, preferably being in the range from 590 to 660 g/l. If fillers are used, bulk densities in the range from 590 to 1200 g/l can occur as a function of the nature and amount of the filler.

The expandable polymer pellets used according to the invention comprise, if appropriate, one or more additives, such as nucleating agents, fillers (e.g. mineral fillers, for example glass fibers), plasticizers, flame retardants, soluble and insoluble inorganic and/or organic dyes and pigments, e.g. IR absorbers, such as carbon black, graphite, or aluminum powder. The additives can by way of example be added to the polymer melt jointly or with spatial separation, e.g. by way of mixers or ancillary extruders.

The total amount of additives is generally from 0 to 30% by weight, preferably from 0 to 20% by weight, based on the total weight of the polymer pellets.

For thermal insulation it is particularly preferable to add graphite, carbon black, aluminum powder, or an IR dye (e.g. indoaniline dyes, oxonol dyes, or anthraquinone dyes).

The amounts generally added of the dyes and pigments are in the range from 0.01 to 30% by weight, preferably in the range from 1 to 5% by weight. For homogeneous and microdisperse distribution of the pigments in the styrene polymer, it can be advantageous, in particular for polar pigments, to use a dispersing agent, e.g. organosilanes, polymers comprising epoxy groups, or maleic-anhydride-grafted styrene polymers. Preferred plasticizers are low-molecular-weight styrene polymers or low-molecular-weight styrene copolymers, fatty acid esters, fatty acid amides, and phthalates, the amounts which can be used of these being from 0.05 to 10% by weight, based on the styrene polymer.

For production of the expandable polymer pellets used according to the invention, the blowing agent is preferably mixed into the polymer melt. The process comprises the stages a) melt production, b) mixing, c) cooling, d) conveying, and e) pelletization. Each of these stages can be executed by the apparatus or apparatus combinations known in plastics processing. Suitable apparatus for mixing to incorporate the materials are static or dynamic mixers, such as extruders. The polymer melt can be taken directly from a polymerization reactor, or produced directly in the mixing extruder or in a separate melting extruder, via melting of polymer pellets. The melt can be cooled in the mixing assemblies or in separate coolers. Examples of pelletization processes are pressurized underwater pelletization, pelletization using rotating knifes, and cooling via spray misting of temperature-control liquids, or spray pelletization. Examples of apparatus arrangements suitable for conduct of the process are:
a) polymerization reactor-static mixer/cooler-pelletizer
b) polymerization reactor-extruder-pelletizer
c) extruder-static mixer-pelletizer
d) extruder-pelletizer

The arrangement can moreover have ancillary extruders for the introduction of additives, e.g. of solids, or of heat-sensitive additives.

The temperature of the polymer melt comprising blowing agent when it is conveyed through the die plate is generally in the range from 140 to 300° C., preferably in the range from 160 to 240° C. There is no need for cooling down to the glass transition temperature region.

The die plate is heated at least to the temperature of the polymer melt comprising blowing agent. The temperature of the die plate is preferably in the range from 20 to 100° C. above the temperature of the polymer melt comprising blowing agent. This inhibits deposition of polymer in the dies and ensures problem-free pelletization.

In order to obtain marketable pellet sizes, the diameter (0) of the die holes at the die exit should be in the range from 0.2 to 1.5 mm, preferably in the range from 0.3 to 1.2 mm, particularly preferably in the range from 0.3 to 0.8 mm. Even after die swell, this can give controlled pellet sizes below 2 mm, in particular in the range from 0.4 to 1.4 mm.

Die swell can be influenced not only by way of the molecular weight distribution but also by the geometry of the die. The die plate preferably has holes whose L/D ratio is at least 2, where the length (L) designates the die region whose diameter is at most equal to the diameter (D) at the die exit. The L/D ratio is preferably in the range from 3 to 20.

The diameter (E) of the holes at the die entry of the die plate should generally be at least twice as large as the diameter (D) at the die exit.

One embodiment of the die plate has holes with conical inlet and with an inlet angle α smaller than 180°, preferably in the range from 30 to 120°. In another embodiment, the die plate has holes with conical outlet and with an outlet angle smaller than 90°, preferably in the range from 15 to 45°. In order to produce controlled pellet size distributions of the styrene polymers, the die plate can be equipped with holes of different exit diameter (D). The various embodiments of die geometry can also be combined with one another.

One particularly preferred process for the production of the expandable polymer pellets used according to the invention comprises the steps of
a) polymerization of styrene, if appropriate, of α-methylstyrene monomers, and of acrylonitrile, to give styrene copolymers A) or polystyrene B),
b) devolatilization of the resultant polymer melt,
c) if appropriate, mixing of the other polymers of components (A), (B), and (C),
d) using a static or dynamic mixer at a temperature of at least 150° C., preferably from 180 to 260° C., for mixing to incorporate the blowing agent and, if appropriate, additives into the polymer melt,
e) cooling of the polymer melt comprising blowing agent to a temperature which is at least 120° C., preferably from 150 to 200° C.,
f) discharge through a die plate with holes whose diameter at the die exit is at most 1.5 mm, and
g) pelletization of the melt comprising blowing agent.

The pelletization in step g) can take place directly downstream of the die plate under water at a pressure in the range from 1 to 25 bar, preferably from 5 to 15 bar.

By virtue of the polymerization process in stage a) and devolatilization process in stage b), a polymer melt is directly available for blowing agent impregnation in stage c), and melting of polymers is not necessary. This is not only more cost-effective but also leads to expandable polymers with low monomer contents, since it avoids the mechanical shear action which generally leads to cleavage to regenerate monomers in the transition section of an extruder. In order to keep the monomer content low, in particular below 500 ppm, it is also advantageous to minimize the input of mechanical and thermal energy in all of the following stages of the process. Compliance with shear rates below 50/sec, preferably from 5 to 30/sec, and temperatures below 260° C., and also short residence times in the range from 1 to 20 minutes, preferably from 2 to 10 minutes, in stages c) to e), is therefore particularly preferable. It is particularly preferable to use exclusively static mixers and static coolers in the entire process. The polymer melt can be conveyed and discharged via pumps, e.g. gear pumps.

Another possibility for reducing monomer content and/or amounts of residual solvent, such as ethylbenzene, consists in providing a high level of devolatilization in stage b) by means of entrainers, such as water, nitrogen or carbon dioxide, or anionic conduct of the polymerization stage a). Anionic polymerization leads not only to polymers with low monomer content but also simultaneously to low contents of oligomers.

In order to improve processability, the finished expandable polymer pellets can be coated using glycerol ester, antistatic agents, or anticaking agents.

In a first step, the expandable, thermoplastic polymer pellets used according to the invention are preferably prefoamed by means of hot air or steam to give foam beads whose density is in the range from 10 to 250 g/l, and in a second step they are fused in a closed mold to give the molded-foam moldings used according to the invention.

Alongside the core layer described, composed of a molded-foam molding, the composite moldings according to the invention comprise at least one further layer. It is preferable that there are one or more further layers bonded to at least two sides of the core layer. It is further preferable that there are one or more further layers bonded to all of the sides of the core layer.

In one embodiment of the invention, the structure of the composite molding is composed of core layer, of one or more outer layers, and of a surface layer.

In another embodiment of the invention, the structure of the composite molding is composed of core layer and of a surface layer.

Preferred as surface layer and, if appropriate, outer layer are aminoplastic resin films, in particular melamine films, PVC (polyvinyl chloride), glassfiber-reinforced plastic (GRP), an example being a composite composed of polyester resin, epoxy resin, or polyamide, and glass fibers, preimpregnated materials, foils, laminates, such as HPL (high-pressure laminate), and CPL (continuous-pressure laminate), veneers, and metal coatings, in particular aluminum coatings.

Preference is likewise given to use of particle board or MDF (medium-density fiberboard), in particular thin particle board and MDF of thickness <3 mm, as paneling on the core layer according to the invention.

Particular preference is given to particle board or MDF which has a surface finish on one side, as a result of lacquering, veneering, an applied film (melamine film), or laminate.

The surface layer is then laminated to the core layer according to the invention by methods known to the person skilled in the art.

By way of example, in the case of a veneer, the glue liquor is applied to the inventive core layer, the veneer is superposed, and the material is laminated with exposure to heat and pressure.

The resin films or laminates used as surface layer are generally produced via impregnation of papers by aqueous resin solutions, e.g. a) soda kraft papers whose weight per unit area is from 50 to 150 g/m², b) printed decorative papers whose weight per unit area is from 50 to 150 g/m², or c) overlay papers whose weight per unit area is from 20 to 50 g/m², where the papers are saturated with the resin solution and/or the resin solution is doctored or spread onto the paper. The substrate is then dried to a residual moisture/water content of from 2 to 8%. The resultant weight per unit area is usually from 100 to 250 g/m² in the case of a) and from 50 to 150 g/m² in the case of b) and of c).

These dried substrates are then laminated to the core layer according to the invention or, if appropriate, to a layer applied between core layer and surface layer, for example a functional layer. The pressure here is usually from 5 to 80 bar, and the press time is generally less than one minute, typically from 10 to 30 seconds, and the press temperature is from about 160 to 200° C.

Production of laminates involves, if appropriate, laminating a plurality of films together to give the laminate. A laminate is usually composed of a plurality of sublayers of impregnated core paper, preferably from 2 to 15 layers of core paper, of one or more impregnated decorative and/or overlay papers, as surface layer, and, if appropriate, of one or more impregnated balancing papers composed, for example, of soda kraft papers.

The pressure is typically below 100 bar, and the press time is usually up to 90 minutes, and the press temperature is generally at most 150° C. The laminates thus produced are then adhesive-bonded to the core layer according to the invention, by processes known to the person skilled in the art.

Examples of materials that can be used for paneling on the core layer according to the invention are any of those manufactured from slatted timber, examples being veneer sheets or plywood sheets, timber materials produced from wood chips, e.g. particle board or OSB (oriented strand board, coarse particle board), and also wood-fiber materials, such as LDF, MDF, and HDF. These timber materials are produced from the corresponding timber particles with addition of natural and/or synthetic binders by hot pressing. Preference is given to OSB, wood-fiber board, and particle board.

The methods used to apply the paneling are known and familiar to the person skilled in the art.

Examples of adhesives that can be used are dispersion adhesives, e.g. casein glue, epoxy resins, formaldehyde condensate resins, e.g. phenolic resins, urea-formaldehyde resins, melamine-formaldehyde resins, melamine-urea-formaldehyde resins, resorcinol resins and phenol-resorcinol resins, isocyanate adhesives, polyurethane adhesives, and hot-melt adhesives.

If one or more layers of the composite molding are composed of materials which can cause formaldehyde emission, it is advantageous to subject the corresponding layer or the composite molding to the polyamine treatment described in WO 2007/082837.

The composite moldings according to the invention can be surface-treated for example by grinding and/or lacquering, after application of the surface layer.

The density of the composite molding according to the invention is preferably in the range from 50 to 300 g/l, particularly preferably from 50 to 150 g/l, in particular from 50 to 100 g/l.

The composite molding according to the invention preferably comprises no frame structure.

The composite molding according to the invention is preferably used for the production of furniture, or of packaging materials, in house building, in drywall construction, or in interior finishing, for example in the form of laminate, insulating material, wall element, or ceiling element.

The examples provide further explanation of the invention but there is no intention that they restrict the same.

### EXAMPLES

### Materials Used

Luran VLP: SAN whose acrylonitrile content is 35% and whose MW is 145 800 (commercially available product from BASF SE)
Luran VLS: AMSAN whose acrylonitrile content is 31% and whose MW is 101 000 (commercially available product from BASF SE)
Luwax AH3: Nucleating agent, polyethylene wax with melting point from 110 to 118° C. and MW 3500 (commercially available product from BASF SE)

### Examples 1 to 4

### Polymer Pellets Used According to the Invention

50% by weight of Luran VLP were melted with 50% by weight of Luran VLS at from 230 to 250° C. in a ZSK 18 twin-screw extruder from Leistritz. 4.5 or 5.0% by weight of sec-pentane, based on the polymer matrix, were then charged to the polymer melt. The polymer melt was then homogenized in two static mixers and cooled to 190° C. By way of an ancillary extruder, 0.2% by weight of Luwax AH3, based on the polymer matrix, was added as nucleating agent to the main melt stream charged with blowing agent. After homogenization by way of two further static mixers, the melt was cooled to from 140° C. to 150° C. and extruded through a heated pelletizing die (4 holes of 0.65 mm bore; pelletizing die temperature: 280° C.). Underwater pelletization was used to chop the polymer strand (underwater pressure 12 bar, water temperature 60° C.), giving minipellets charged with blowing agent and having narrow particle size distribution (d′=1.2 mm).

TABLE 1
(examples 1 to 4) Production of the pellets used
according to the invention

Example

| | 1 | 2 | 3 | 4 |
|---|---|---|---|---|
| Pentane (%) | 4.5 | 4.5 | 5.0 | 5.0 |
| Bulk density (g/l) | 67.6 | 75.2 | 48.5 | 26.7 |
| Cell number (1/mm) | 4.3 | 4.1 | 10.5 | 12.4 |
| Compressive stress (kPa) | | | | |
| 10% compression | 451 | 542 | 362 | 125 |
| 25% compression | 640 | 755 | 445 | 157 |
| (EN ISO 3386-1) | | | | |

### Example 5

### Production of a Foam Sheet as Core Layer

50% by weight of Luran VLP were melted with 50% by weight of Luran VLS at from 230 to 250° C. in a ZSK 18 twin-screw extruder from Leistritz. 5.0% by weight of sec-pentane and also 1.0% by weight of ethanol, based on the polymer matrix, were then charged to the polymer melt. The polymer melt was then homogenized in two static mixers and cooled to 190° C. By way of an ancillary extruder, 0.2% by weight of Luwax AH3, based on the polymer matrix, was added as nucleating agent to the main melt stream charged with blowing agent. After homogenization by way of two further static mixers, the melt was cooled to from 140° C. to 150° C. and extruded through a heated pelletizing die (4 holes of 0.65 mm bore; pelletizing die temperature: 280° C.). Underwater pelletization was used to chop the polymer strand (underwater pressure 12 bar, water temperature 60° C.), giving minipellets charged with blowing agent and having narrow particle size distribution (d′=1.2 mm).

The pellets charged with blowing agent were prefoamed in an EPS prefoamer to give foam beads with various densities (from 20 to 120 g/l), and processed in an EPS molding machine at a gauge pressure of 0.5 bar to give moldings.

### Example 6

### Production of a Composite Molding Composed of Foam Sheet, Resopal Layer, and Veneer Layer

A foam sheet (blend composed of 50% by weight of SAN (Luran® 3380) and 50% by weight of AMSAN (Luran® KR2256)) was laminated to a Resopal sheet and to a wood veneer. The adhesive used comprised Kaurit glue, and the press conditions were from 90 to 95° C. and a gauge pressure of 100 atmospheres.

Conventional anchors (e.g. HUD-1 or HLD 2 from Hilti Deutschland GmbH or HM from Fischwerke GmbH & Co KG) were successfully sunk into the resultant board. A circular saw was moreover successfully used to cut the board.

### Example 7

### Production of a Composite Molding Composed of Foam Sheet and of Beech Veneer on Both Sides

A beech veneer of thickness 1.5 mm was adhesive-bonded to both sides of a foam sheet according to example 6 of size 20×20 cm² and thickness 0.5 cm, with density of 70 g/l (glue applied: 200 g/m² of Kaurit glue (urea resin glue, BASF SE, Ludwigshafen, Germany), screw press, press time 120 min. at room temperature).

The resultant composite moldings were tested for shear strength V20 and transverse tensile strength V20.

The values achieved: 0.33N/mm and, respectively, 0.29 N/mm, meet the requirements placed by way of example on particle board.

### Example 8

### Production of a Composite Molding Composed of Foam Sheet and of Beech Veneer on One Side

A beech veneer of thickness 1.5 mm was adhesive-bonded to one side of a foam sheet according to example 6 of size 20×20 cm² and thickness 0.5 cm, with density of 70 g/l (glue applied: 170 g/m² of Kaurit glue, screw press, press time 120 min. at room temperature).

### Example 9

### Production of a Composite Molding Composed of Foam Sheet and Medium-Density Fiberboard (MDF) on Both Sides

A MDF (Homanit GmbH & CO KG, Herzberg am Harz, Germany) of thickness 3.5 mm was adhesive-bonded to both sides of a foam sheet according to example 6 of size 20×20 cm² and thickness 0.5 cm, with density of 70 g/l (glue applied: 200 g/m² of Kaurit glue, screw press, press time 120 min. at room temperature).

1-12. (canceled)

13. A composite molding comprising a core layer and one or more further layers, where the core layer takes the form of a molded-foam molding with a density in the range from 10 to 250 g/l, obtainable via fusion of prefoamed foam beads composed of expandable, thermoplastic polymer pellets comprising
from 5 to 100% by weight of an SAN component (A) comprising
a1) from 5 to 100% by weight (based on A) of a styrene-acrylonitrile copolymer
a2) from 0 to 95% by weight (based on A) of an α-methylstyrene-acrylonitrile copolymer and/or α-methylstyrene-styrene-acrylonitrile terpolymer;
from 0 to 95% by weight of polystyrene (B), and
from 0 to 95% by weight of a thermoplastic polymer (C) different from (A) and (B), and obtainable from a polymer melt comprising blowing agent comprising one or more blowing agents homogeneously distributed in a total proportion of from 2 to 10% by weight, based on the polymer melt comprising blowing agent from the group of aliphatic hydrocarbons having from 2 to 8 carbon atoms, alcohols, ketones, ethers, esters and halogenated hydrocarbons.

14. The composite molding according to claim 13, where the density of the core layer is in the range from 50 to 150 g/l.

15. The composite molding according to claim 13, with a density in the range from 50 to 300 g/l.

16. The composite molding according to claim 13, where component (a2) of the molded foam is composed of an α-methylstyrene-acrylonitrile copolymer (a 21).

17. The composite molding according to claim 13, where component (a2) of the molded foam comprises an α-methylstyrene-acrylonitrile copolymer (a 21) which is obtainable from (a 211) from 10 to 50% by weight of acrylonitrile and (a 212) from 50 to 90% by weight of α-methylstyrene.

18. The composite molding according to claim 13, where component A of the molded foam comprises
from 20 to 100% by weight (based on A) of a styrene-acrylonitrile copolymer (a1), and
from 0 to 80% by weight (based on A) of an α-methylstyrene-acrylonitrile copolymer (a2).

19. The composite molding according to claim 13, where component A of the molded foam comprises
from 20 to 90% by weight (based on A) of a styrene-acrylonitrile copolymer (a1), and
from 10 to 80% by weight (based on A) of an α-methylstyrene-acrylonitrile copolymer (a2).

20. The composite molding according to claim 13, where the molded foam comprises one or more additives from the group of nucleating agents, fillers, plasticizers, flame retardants, and inorganic and organic dyes and pigments.

21. The composite molding according to claim 20, where the molded foam comprises graphite particles.

22. The composite molding according to claim 13, where at least one further layer is composed of aluminum, of high-pressure-laminate, of wood veneer, of GRP, of synthetic resin, or of PVC.

23. A process for the production of a composite molding according to claim 13, comprising the steps of
a) polymerization of styrene monomers, optionally, α-methylstyrene, and acrylonitrile, to give styrene copolymers A) or polystyrene B),
b) devolatilization of the resultant polymer melt,
c) optionally, mixing of the other polymers of components (A), (B), and (C),
d) using a static or dynamic mixer at a temperature of at least 150° C. for mixing to incorporate the blowing agent and, optionally, additives into the polymer melt,
e) cooling of the polymer melt comprising blowing agent to a temperature which is at least 120° C.,
f) discharge through a die plate with holes whose diameter at the die exit is at most 1.5 mm,
g) pelletization of the melt comprising blowing agent,
h) foaming and fusion of the resultant pellets to give a molding, and
i) application of at least one further layer.

24. The composite molding according to claim 13 for use in furniture construction.

25. The process according to claim 23, comprising using the static or dynamic mixer at a temperature of from 180 to 260° C.

26. The process according to claim 23, comprising cooling of the polymer melt comprising blowing agent to a temperature which is from 150 to 200° C.
